(19) United States
(12) Patent Application Publication
(10) Pub. No.: US 2025/0137616 A1
(43) Pub. Date: May 1, 2025

(54) LAMP FOR AN ARTIFICIAL SKYLIGHT

(71) Applicant: CHRISTIE DIGITAL SYSTEMS USA, INC., Cypress, CA (US)

(72) Inventor: Jordan Evalds Huxley PRIEDE, Waterloo (CA)

(21) Appl. No.: 18/386,071

(22) Filed: Nov. 1, 2023

(51) Int. Cl. F21V 9/02; F21V 5/04; F21V 7/04

(52) U.S. Cl. CPC F21V 9/02; F21V 5/045; F21V 7/04

(57) ABSTRACT

A lamp for an artificial skylight is provided. The lamp includes: a housing having an interior and an exterior, the interior having a light-source end and light-emitting end opposite the light-source end; an aperture through the light-source end of the interior; a light source located at or behind the aperture, the light source arranged to emit light through the aperture towards the light-emitting end; and a collimating lens located at the light-emitting end. The interior comprises a non-conical curved surface, between the light-emitting end and the light-source end optimized to maximize average perceived intensity of diffuse reflected light relative to at least a conical surface, and the non-conical curved surface comprises a scattering surface.

### BACKGROUND

Artificial skylights are becoming more popular, however such artificial skylights are generally large, bulky, and heavy, and hence can be challenging to hang and/or mount on ceilings.

### BRIEF DESCRIPTIONS OF THE DRAWINGS

For a better understanding of the various examples described herein and to show more clearly how they may be carried into effect, reference will now be made, by way of example only, to the accompanying drawings in which:

FIG. 1 depicts a lamp for an artificial skylight, according to non-limiting examples.

FIG. 2 depicts a cross-section through a longitudinal axis of an interior non-conical curved surface the lamp of FIG. 1, along with a collimating lens and light source thereof according to non-limiting examples.

FIG. 3 depicts a profile curve of a non-conical curved surface of an example lamp as provided herein, the shape of the profile curve adapted for solder points to a light source of the example lamp, according to non-limiting examples.

FIG. 4 depicts a profile curve of a conical curved surface of a lamp, according to non-limiting examples.

FIG. 5 depicts modelled diffuse reflected brightness of a non-conical surface and a conical curved surface of a lamp.

FIG. 6 depicts an upward view of a system of lamps in a respective upper portion and, in a lower portion, the system is depicted schematically in a side view, as attached to a ceiling, with a viewer at a first positions relative to the system, according to non-limiting examples.

FIG. 7 depicts an upward view of the system of FIG. 6, with the viewer at a second position relative to the system, according to non-limiting examples.

FIG. 8 depicts a bottom perspective view of an alternative housing of the lamp of FIG. 1, according to non-limiting examples.

FIG. 9 depicts a top perspective view of the alternative housing of FIG. 8, according to non-limiting examples.

FIG. 10 depicts the system of FIG. 6 and FIG. 7 adapted to include a unit for controlling scattering of light of the system, according to non-limiting examples.

FIG. 11 depicts a side view of a lamp that includes a unit for controlling brightness and/or scattering of light of the system, according to non-limiting examples.

FIG. 12 depicts an end view of a lamp that includes a unit for controlling brightness and/or scattering of light of the system, according to non-limiting examples.

### DETAILED DESCRIPTION

Artificial skylights are becoming more popular, however such artificial skylights are generally large, bulky, and heavy, and hence can be challenging to hang on ceilings. Furthermore, at least due to the size, such artificial skylights may have significant cost. For example, to achieve a large artificial skylight, such devices may generally rely on large flat panel displays (e.g., liquid crystal displays (LCD) greater than 25 cm across) and a depth of optics to provide light from such displays generally increase with width and height of such displays. Hence a “large” “skylight” may require a deep internal structure (e.g., due to long focal lengths of lenses thereof) which generally increases the weight, bulkiness (e.g., depth) and cost of such devices. Alternatively, such devices often rely on Rayleigh scattering to achieve a blue sky effect with one main illumination source illuminating a “sky” portion of the device and that also provides a sunlight effect, which can be bulky.

As such, provided herein is a lamp that may be tiled with a plurality of such lamps, and mounted to a ceiling to form an artificial skylight.

In particular, the lamp comprises a housing having an interior and an exterior, the interior having a light-source end and a light-emitting end opposite the light-source end, with a light source at the light-source end, and a collimating lens located at the light-emitting end. In general, the light source is located at a focal length from the collimating lens and/or at a focal point of the collimating lens. The interior of the housing comprises a non-conical curved surface (e.g., having rotational symmetry about a longitudinal axis through the lamp), between the light-emitting end and the light-source end. The non-conical curved surface is generally selected and/or optimized to maximize average perceived intensity of diffuse reflected light (e.g., relative to at least a conical surface). The non-conical curved surface further comprises a scattering (e.g., a diffuse) surface.

The non-conical curved surface may be further colored blue, sky blue and/or any other suitable color, for example of a sky. While a wide range of blues may correspond to “sky blue”, for example as on some days and/or in some regions, a blue of the sky may be lighter or darker than other days and/or other regions, an average of such blues may be selected for the color of the non-conical curved surface. Alternatively, given different regions to which the lamps are to be shipped, the lamps may be provided in different shades of sky blue that correspond to different colors of the sky in the different regions.

The exterior of the housing is generally in a tileable shape, such as a hexagonal shape (amongst other possibilities, such as a triangle, a square, a rectangle, a circle, and the like), so that the lamp may be tiled with other lamps, for example when mounted on a ceiling. Hereafter, for simplicity, reference will be made to an artificial skylight formed from a plurality of (e.g., tiled) lamps mounted to a ceiling, though such a plurality of tiled lamps may alternatively be mounted to a wall to form an artificial window.

In particular, the non-conical curved surface that comprises a scattering surface, with the light source located at a focal length of the collimating lens, causes a viewer located under a plurality of the lamps to view the “sun” directly overhead (e.g., in the sky); and as the non-conical curved surface (e.g., the scattering surface) is a sky blue, the viewer, viewing plurality of the lamps at an angle (e.g., lamps that are not directly overhead), will see a sky blue colored “sky” beside the “sun”. Hence, the overall appearance is of the sun in the sky. Due to the collimating lenses of the plurality of the lamps, the “sun” will appear to be stationary at a great distance from the viewer (e.g., in the “sky”), as the viewer moves under the plurality of the lamps.

In general, the non-conical curved surface is optimized to maximize average perceived intensity of diffuse reflected light (e.g., relative to at least a conical surface). In this manner, a brightness of the “sky” beside or behind the “sun”, represented by the plurality of the lamps, may generally appear about uniform. Put another way, by optimizing the non-conical curved surface to maximize average perceived intensity of diffuse reflected light relative to at least a conical surface, the “sun” appears, to the viewer, as a bright light in an about uniform (e.g., sky blue) background. The scattering and/or diffuse nature of the non-conical curved surface, optimized to maximize average perceived intensity of diffuse reflected light, generally minimizes non-uniformities of light scattered from the non-conical curved surface, which would deter from the illusion of the sun in an about uniform background.

The non-conical curved surface is generally non-conical (e.g., and non-linear) as conical surfaces and/or linear surfaces cannot achieve the same effect as effectively (e.g., the effect of the sun in an about uniform background), as such conical surfaces and/or linear surfaces have very low relative uniformity of average perceived intensity of diffuse reflected light when incorporated into lamps with a light source at one end. Put another way, when a light source is located at one end of a rotationally symmetrical conical surface and/or linear surface, light scattered from the conical surface and/or linear surface is highly non-uniform.

Indeed, use of a non-conical curved surface enables adjustment of the shape (e.g., prior to manufacture) of the interior of the lamp to maximize average perceived intensity of diffuse reflected light. For example, a cross-section through a longitudinal axis of the non-conical curved surface may follow a fifth order polynomial with an origin of the fifth order polynomial beginning at an edge of an aperture at which the light source is located, however, use of any suitable order polynomial is within the scope of the present specification (e.g., a third order polynomial, a fourth order polynomial, a sixth order polynomial, and higher), as is any other suitable non-conical surface with a maximized average perceived intensity of diffuse reflected light.

The lamps, as provided herein, are smaller and lighter, and easier to install in a tiled array, as compared to larger monolithic devices that may have a surface area that is the same and/or similar to a plurality of such tiled lamps. Put another way, comparing sixty-three tiled lamps as provided herein (e.g., 3 rows of ten lamps alternating with 3 rows of eleven lamps which may be tiled together and mounted in a two foot by four foot drop-ceiling light troffer), to a larger monolithic device that has a surface area that is sixty-three times the size of a single tiled lamp, the larger monolithic device may require a lamp that is at least sixty-three times the power of a respective lamp of a single tiled device (e.g., to achieve a similar brightness), and such a lamp with sixty-three times the power may be more expensive than a single tiled lamp, and/or may be more difficult to cool than the sixty-three lamps as provided herein. Hence, tiled lamps as provided herein may be cheaper and easier to cool than a larger monolithic prior art device.

In this manner, an inexpensive, low weight artificial skylight, which is relatively easy to cool, may be provided, which may be of any suitable size and/or shape, depending on a number of the lamps tiled together, for example in an array. In particular, as each of the lamps is of a relatively small size and low weight, mounting the lamps, either individually or tiled together in a troffer, to a ceiling may generally enable ease of assembling a larger artificial skylight. Furthermore, as the depth of the lamps may be relatively smaller than prior art devices, such lamps may generally occupy less space and/or be less obtrusive than prior art devices. Furthermore, manufacturing costs and shipping costs of such smaller lamps may be reduced relative to larger, bulkier prior art devices. For example, a housing of such a lamp may be inexpensively manufactured from (e.g., low weight) plastic, using injection molding techniques.

Furthermore, the lamps may be tiled in any suitable shape. For example, while an array of the lamps may be arranged on a ceiling with respective same numbers of the lamps in rows and columns, the lamps may be arranged in other shapes, such as a cross shape, irregular shapes, and the like.

An aspect of the present specification provides a lamp comprising: a housing having an interior and an exterior, the interior having a light-source end and light-emitting end opposite the light-source end; an aperture through the light-source end of the interior; a light source located at or behind the aperture, the light source arranged to emit light through the aperture towards the light-emitting end; and a collimating lens located at the light-emitting end, the interior comprising a non-conical curved surface, between the light-emitting end and the light-source end optimized to maximize average perceived intensity of diffuse reflected light relative to at least a conical surface, and the non-conical curved surface comprises a scattering surface.

Another aspect of the present specification provides a system comprising: a plurality of lamps arranged in an array, each of the plurality of lamps comprising: a housing having an interior and an exterior, the interior having a light-source end and light-emitting end opposite the light-source end; an aperture through the light-source end of the interior; a light source located at or behind the aperture, the light source arranged to emit light through the aperture towards the light-emitting end; and a collimating lens located at the light-emitting end, the interior comprising a non-conical curved surface, between the light-emitting end and the light-source end optimized to maximize average perceived intensity of diffuse reflected light relative to at least a conical surface, and the interior comprising a scattering surface.

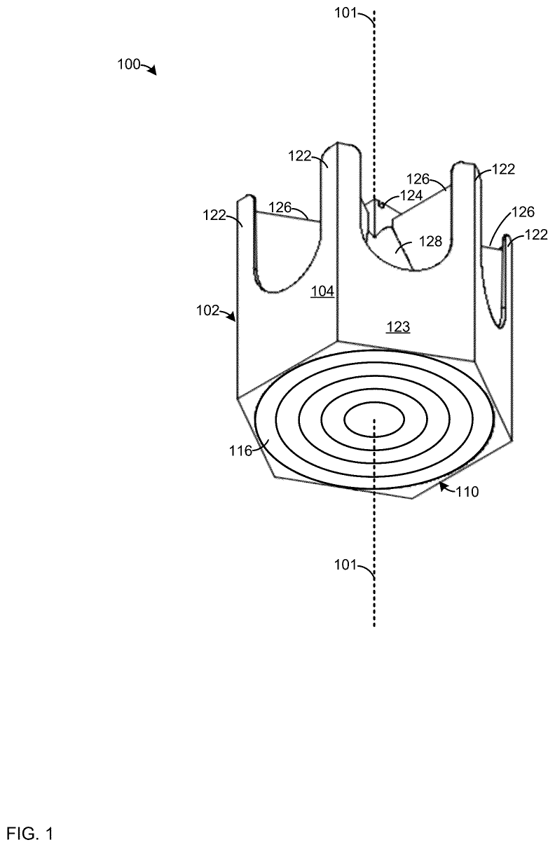

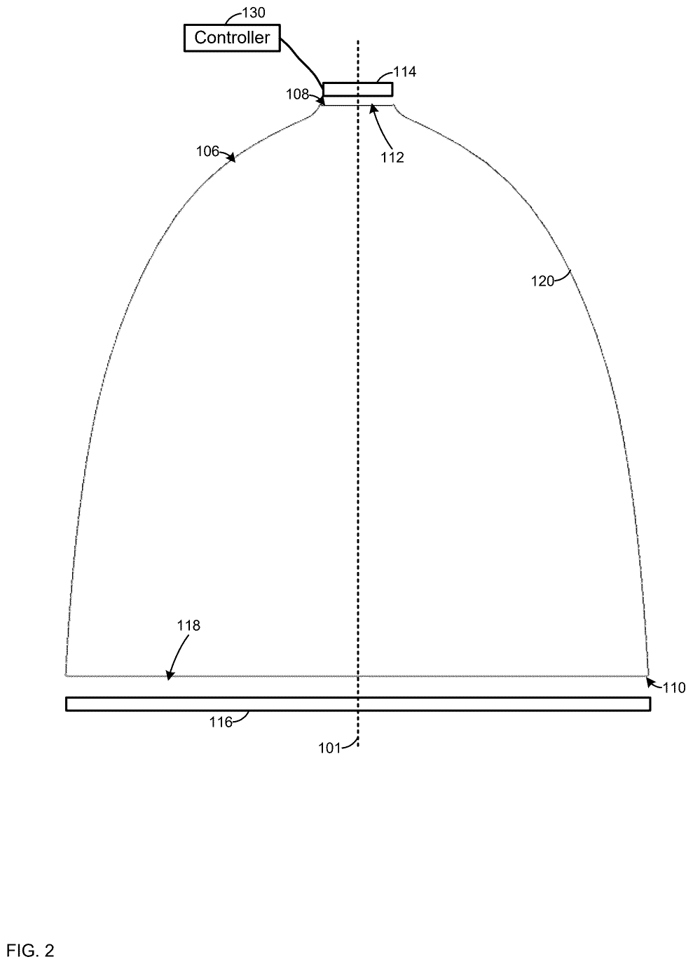

Attention is next directed to FIG. 1 and FIG. 2 which respectively depict a perspective view of a lamp 100 and a cross-section of an interior of the lamp 100 along a longitudinal axis 101 (depicted in broken lines), as well as locations of certain components of the lamp 100 relative to the interior surface.

The lamp 100 generally comprises a housing 102 having an exterior 104 and, as best seen in FIG. 2, an interior 106, the interior 106 having a light-source end 108 and light-emitting end 110 opposite the light-source end 108.

As also best seen in FIG. 2, the lamp 100 further comprises an aperture 112 through the light-source end 108 of the interior 106, and a light source 114 located at or behind the aperture 112, the light source 114 arranged to emit light through the aperture 112 towards the light-emitting end 110. For clarity, the light source 114 is depicted in FIG. 2 as offset from the aperture 112 (e.g., along the longitudinal axis 101), though the light source 114 may be mounted directly behind or at the aperture 112. Furthermore, it is understood that, in some examples, a portion of the light source 114 may protrude through the aperture 112 towards the light-emitting end 110. Furthermore, while not depicted, a heatsink may be mounted at a back-side of the light source 114 (e.g., a side opposite the aperture 112).

The light source 114 may comprise a light emitting diode (LED) and/or a plurality (e.g., an array) of LEDs, though any suitable light source is within the scope of the present specification. Furthermore, the light source 114 may have electrical contacts at a rear side or a front (e.g., aperture or light-emitting end facing) side, with the size and/or shape of the aperture 112 adapted accordingly (e.g., to allow for clearance of solder points when the electrical contacts are at the front (e.g., aperture or light-emitting end facing) side. The aperture 112, however, may generally be circular, or any other suitable shape.

As seen in both FIG. 1 and FIG. 2, the lamp 100 further comprises a collimating lens 116 located at the light-emitting end 110, and the housing 102 at the light-emitting end 110 may be adapted accordingly to mount the collimating lens 116 to the housing 102. For clarity, the collimating lens 116 is depicted in FIG. 2 as offset from the light-emitting end 110 (e.g., along the longitudinal axis 101), though the collimating lens 116 may be mounted directly at a respective exit aperture 118 through the light-emitting end 110. The respective exit aperture 118 may be circular, or any other suitable shape.

The collimating lens 116 may comprise a Fresnel, though any suitable collimating lens is within the scope of the present specification. For example, the collimating lens 116 may comprise any suitable collimating lens of any suitable shape and size, though in particular examples the collimating lens 116 may comprise a collimating Fresnel lens to minimize depth and weight of the lamp 100. However, the collimating lens 116 may comprise any suitable collimating lens including, but not limited to, a spherical (or aspherical) lens fabricated from any suitable optical material, such as any suitable type of optical glass and/or optical plastic.

Furthermore, in some examples a diameter of the collimating lens 116 may be in a range of about 80 mm to about 120 mm, and a focal length of the collimating lens 116 may be in a range of about 80 mm to about 120 mm, and the light source 114 may be located at a focal point of the collimating lens 116. In particular, such dimensions may lead to a low profile (e.g., in a range of about 80 mm to about 120 mm) artificial skylight and, when the housing 102 is manufactured from light weight material, such as any suitable plastic, such an artificial skylight may also generally be light weight. It is understood that the aforementioned heatsink may add some depth to the lamp 100, but generally such heatsinks will be small compared to the focal length of the collimating lens 116 (e.g., in a prototype of the lamp 100, a heatsink was about 3 cm thick as compared to a 100 mm focal length of a Fresnel lens thereof).

The interior 106 comprises a non-conical curved surface 120, between the light-source end 108 and the light-emitting end 110, the non-conical curved surface 120 optimized to maximize average perceived intensity of diffuse reflected light, relative to at least a conical surface. The non-conical curved surface 120 is further understood to comprise a scattering (e.g., diffuse) surface, such that light from the light-source end 108 is scattered by the non-conical curved surface 120 (e.g., rather than specularly reflected). In general, to achieve such a scattering (e.g., diffuse) surface, non-conical curved surface 120 may be coated with any suitable scattering material, including, but not limited to, matte-based paints, and the like. Indeed, a roughness of the non-conical curved surface 120 and/or a material coating the surface, is selected to minimize and/or eliminate specular reflections therefrom. Furthermore, the non-conical curved surface 120 widens from the light-source end 108 to light-emitting end 110, however the non-conical curved surface 120 may not bulge out past the collimating lens 116, as described below.

The non-conical curved surface 120 is generally rotationally symmetric about the longitudinal axis 101 and the apertures 112, 118 may be generally circular accordingly, though the apertures 112, 118 may be any suitable shape, such as hexagonal, and the like (e.g., and the apertures 112, 118 may be different shapes). Similarly, the light source 114 and the collimating lens 116 may be generally circular, the light source 114 and the collimating lens 116 may be any suitable respective shape.

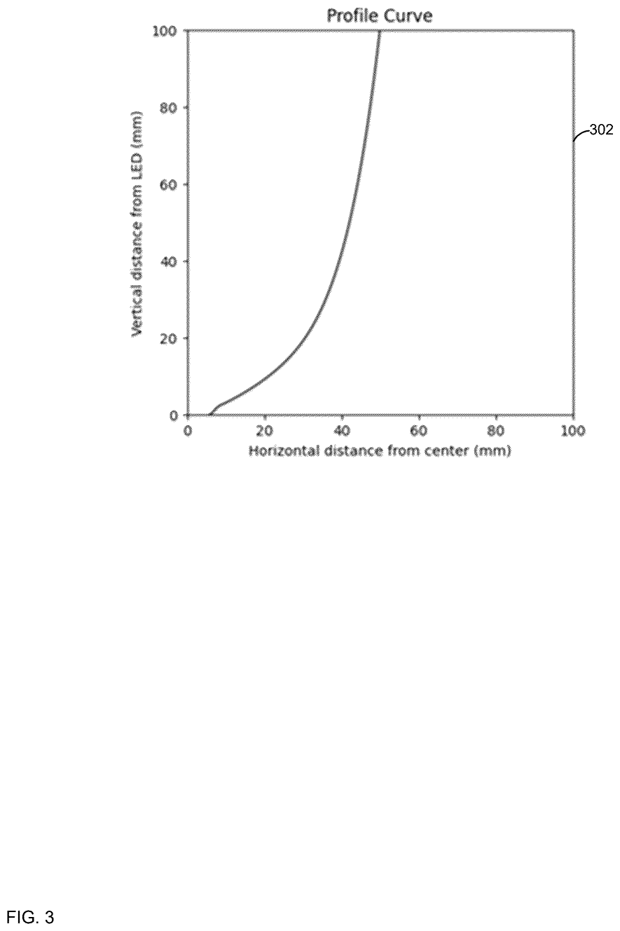

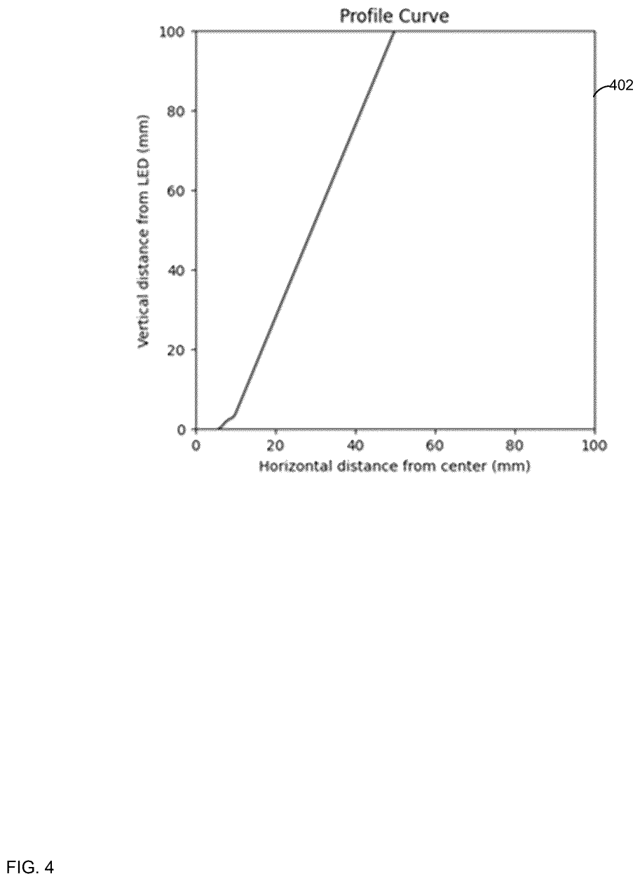

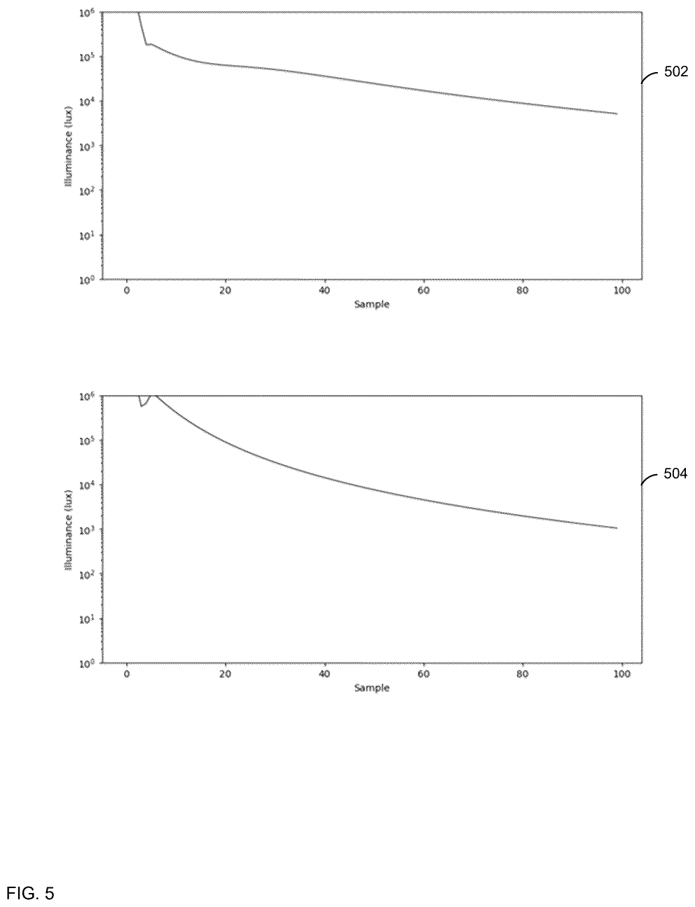

The non-conical curved surface 120 may be any suitable shape, and/or follow any suitable function, optimized to maximize average perceived intensity of diffuse reflected light of the non-conical curved surface 120 as described below with respect to FIG. 3, FIG. 4 and FIG. 5.

However, with reference to FIG. 1, the exterior 104 of the housing 102 generally comprises a tileable shape in cross-section, at least at the light-emitting end 110, for example through a plane, with the longitudinal axis 101 of the housing define a normal of such a plane. For example, as depicted in FIG. 1, the exterior 104 of the housing 102 may be hexagonal in cross-section, at least at the light-emitting end 110. However, housing 102 may alternatively be triangular, square, rectangular, or circular (e.g., which also allows for hexagonal tiling), in cross-section.

As depicted, the exterior 104 of the housing 102 may be shaped for ease of manufacture and/or cooling. For example, as depicted, the exterior 104 may be integral around the collimating lens 116, but may have wings 122 and the like extending from an integral region 123, for example to form cutouts in a region of the housing 102 around a portion 124 of the housing 102 that houses the light source 114, with support walls 126 extending from the wings 122 to an external portion 128 of the curved surface 120. While only four wings 122 and three support walls 126 are depicted in FIG. 1, it is understood that there is one wing 122 for each corner of the hexagon of the housing 102, for a total of six wings 122, and a support wall 126 extending from each wing 122, for a total of six support walls 126, though the housing 102 may have fewer wings 122 and/or support walls 126 (e.g., a wing 122 for every two support walls 126 and/or a number of the wings 122 may be the same as a number of the support walls 126). Nonetheless, the housing 102 having hexagonal symmetry around the longitudinal axis 101 may reduce manufacturing complexities. For example, the housing 102 may be manufactured from any suitable plastic using injection molding techniques and a relatively symmetrical housing 102 may reduce tooling costs thereof.

Furthermore, the non-conical curved surface 120 may be colored in a range of 1931 CIE (Commission Internationale de l'éclairage) corresponding to one or more of blue and a color of the sky. For example, the non-conical curved surface 120 may have a color in a 1931 CIE coordinate range of about (X:0.200 Y:0.100) to (X:0.150 Y:0.200) to (X:0.300 Y:0.340); in other examples, the non-conical curved surface 120 may have a color in a 1931 CIE coordinate range of about (X:0.200 Y:0.100) to (X:0.150 Y:0.200) to (X:0.380 Y:0.377) (e.g., which includes a color temperature of 4000K. Put another way, the non-conical curved surface 120 may have a color in a 1931 CIE coordinate range of one of: [(X:0.200 Y:0.100) to (X:0.150 Y:0.200) to (X:0.300 Y:0.340)] or [(X:0.200 Y:0.100) to (X:0.150 Y:0.200) to (X:0.380 Y:0.377)]. However, any suitable range of 1931 CIE coordinates corresponding to blue, or any other suitable color, and/or color temperature are within the scope of the present specification. Indeed, blue, or any other suitable color, may be specified using any suitable system including, but not limited to CIELAB coordinates, Pantone™ colors, and the like. The color of the non-conical curved surface 120 may be provided via a color of the material from which the non-conical curved surface 120 is manufactured and/or via paint and/or other coloring materials applied to the non-conical curved surface 120 after manufacture.

Put another way, the non-conical curved surface 120 may be selected to maximize how much light from the light source 114 exits the collimating lens 116, while also being lit uniformly enough such that a “blue sky” provided by color of the non-conical curved surface 120 is not obviously fake (e.g., a human may generally easily detect such a fake sky). In practice, optimizing the non-conical curved surface 120 for overall average diffuse brightness results in such an outcome.

However, a color of light emitted by the light source 114 may affect the color of the non-conical curved surface 120. For example, the light source 114 may comprise an LED having a correlated color temperature (CCT) in a range of about 2700K to about 6500K (e.g., which generally correspond to colors of the sun), and a color of the non-conical curved surface 120 may selected such that, when light from the light source 114 is scattered from the non-conical curved surface 120, the light corresponds to one or more of blue and a color of the sky.

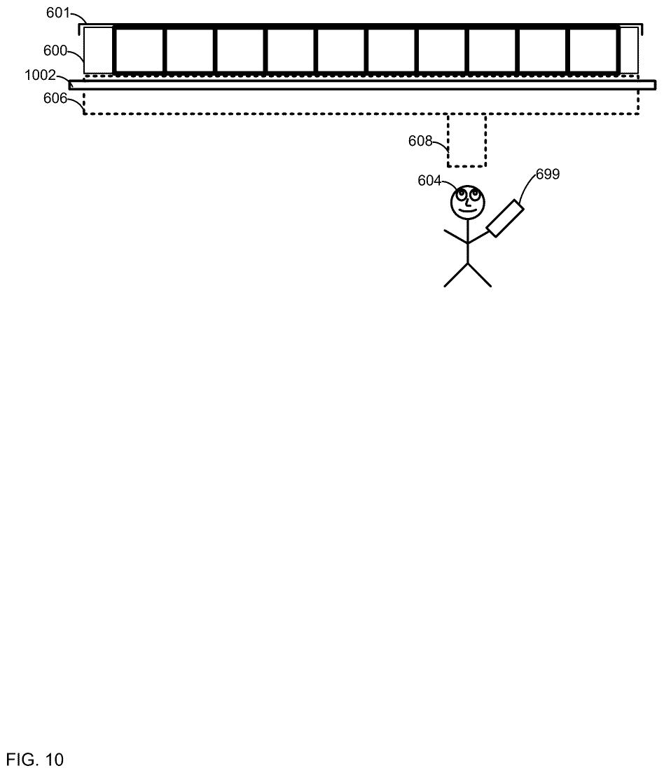

Furthermore, optionally, the color of the light source 114 may be tunable in a range of about 2700K to about 6500K, for example via an optional controller 130 connected to the light source 114, that may be controlled wirelessly (e.g., via a wireless remote control), or in a wired manner (e.g., via a wall switch and/or dimmer switch connected to the controller 130), and/or in any other suitable manner. The controller 130 may comprise a processor and a voltage and/or current controller for controlling voltage and/or current, and the like, to the light source 114 to control the color and/or brightness of the light source 114. Put another way, the light source 114 may be dimmable and/or a color of the light source 114 may be controlled. It is furthermore understood that the controller 130 may be interconnected with other controllers 130 of other lamps 100, and the controller 130 and/or the controllers 130 may be connected to a power source to control power to the light sources 114 of the lamps 100. A similar controller 130 may be provided when the color of the light source 114 is not tunable, however, in these examples, such a controller 130 may be configured to provide power to the light source 114 to turn the light source 114 on and off, and/or to dim and/or control a brightness of the light source 114 (e.g., through pulse width modulation (PWM), and the like). Furthermore, the light source 114 and/or the controller 130 may be powered via a connection to a mains power supply (e.g., via an AC (alternating current) to DC (direct current) converter) and/or via one or more batteries and/or power cells, and the like. Furthermore, as will be explained at least with respect to FIG. 10, a plurality of the lamps 100 may be tiled together (e.g., in a troffer) and controlled with a single controller 130, or a plurality of controllers 130 (e.g., one controller 130 for each lamp 100), and the single controller 130 or the plurality of controllers 130 may be powered by via a common AC to DC power, connected to a mains power supply. When a plurality of controllers 130 are used, the plurality of controllers 130, and a plurality of lamps 100 controlled by the plurality of controllers 130, may be configured to dim and/or change color in unison.

Example shapes and/or profile curves of the non-conical curved surface 120 are next described in more detail.

In particular, attention is next directed to FIG. 3, FIG. 4 which respectively depict graphs 302, 402, the graphs 302, 402 respectively depicting an example profile curve of a shape of the non-conical curved surface 120 (e.g., vertical distance, in mm, from an LED light source 114 as a function of horizontal distance, in mm, from a center of the aperture 112, and/or a cross-section through the longitudinal axis 101) and an example profile curve of a conical shape of a curved surface of a lamp (e.g., to contrast with the graph 302).

As is clearly seen at the graph 302, the profile curve begins at a “non-zero” point, corresponding to an edge of the aperture 112 (and “0” corresponds to a center of the aperture 112) and ends at a point corresponding to an edge of the exit aperture 118; the graph 502 begins and ends similar respective points. Furthermore, the respective non-conical curved surface 120 represented by the graph 302 is understood to have rotational symmetry about the longitudinal axis 101. Similarly, the graph 402 of a conical shape of a curved surface also has rotational symmetry. Put another way, the graphs 302, 402 represent only “half” of a cross-section of corresponding surfaces. Put yet another way, curved surfaces defined by the graphs 302, 402 are understood to be surfaces of revolution, for example about a longitudinal axis (e.g., such as the longitudinal axis 101, which may also be referred to as an azimuthal axis of a surface of revolution). Hence, the non-conical curved surface 120 may comprise a surface of revolution about the longitudinal axis 101 and/or an azimuthal axis.

Furthermore, at the graph 302, a fixed start point and a fixed end point were selected based on a given radius of the light source 114 and/or the aperture 112, a given radius of the collimating lens 116, and a given focal length of the collimating lens 116.

In particular, at the graph 302, a geometry of the aperture 112 was selected that provides for clearance of solder points of the light source 114 (e.g., assuming that the light source 114 has electrical connections on an aperture and/or light emitting side thereof).

Alternatively, though not depicted, a geometry of the aperture 112 may selected that does not take into account such solder points (e.g., assuming that the light source 114 has electrical connections on a rear side, opposite an aperture and/or light emitting side thereof and/or assuming that the light source 114 has electrical connections on an aperture and/or light emitting side thereof).

The graph 302 was obtained using a fifth order polynomial and an optimization algorithm that varied coefficients of the fifth order polynomial to maximize average perceived intensity of diffuse reflected brightness relative to average perceived intensity of diffuse reflected brightness at least the conical surface represented by the graph 402. Put another way, the geometries of the profile curve of the graph 302 was entered into the optimization algorithm, which varied coefficients of the fifth order polynomial until the average relative perceived intensity of diffuse reflected brightness was maximized.

Put yet another way, it is understood that the terms “non-conical” and “conical” as used herein refer to mathematical definitions of such terms. In particular, a generic polynomial that describes the graphs 302, 402, may be:

$$F ( x ) = {\sum }_{n = 0}^{N} ( {a}_{n} {x}^{n} ) \qquad EQUATION ( 1 )$$

In Equation (1), “F (x)” is the polynomial function, “x” is a horizontal distance from a center of an aperture of a curved surface, “N” is an order of the function (e.g., an order of the polynomial), and “an” are coefficients of the polynomial function, which may be optimized to maximize average perceived intensity of diffuse reflected light. For conical surfaces, in Equation (1), N=1, and for non-conical surfaces in Equation (1), N is greater than 1 (e.g., with at least coefficients “an” for N greater than 1 being non-zero). Hence, references to conical surfaces as described herein are understood to be defined by Equation (1), with N=1, and non-conical surfaces as described herein, such as the non-conical surface 120, optimized to maximize average perceived intensity of diffuse reflected light relative to at least a conical surface, are either defined by Equation (1), with N being greater than 1, or any other suitable surface that does not meet the conditions defined with Equation (1) with N=1. When the non-conical surface 120 is defined by Equation (1), it has been heuristically determined that a fifth order polynomial (e.g., N=5) may provide an optimal balance between complexity of the non-conical surface 120 and maximizing average perceived intensity of diffuse reflected light (e.g., for sixth order polynomials and higher, any small increases in maximized average perceived intensity of diffuse reflected light occur relative to fifth order polynomials). However, the non-conical surface 120 may comprise any non-conical surface (e.g., that is not conical as defined by Equation (1), with N=1) optimized to maximize average perceived intensity of diffuse reflected light relative to at least a conical surface, and may not be defined by Equation (1).

Put another way, a cross-section through the longitudinal axis 101 of the non-conical curved surface 120 may follow a fifth order polynomial with an origin of the fifth order polynomial beginning at an edge of the aperture 112.

It is further understood that the term “perceived intensity” is not a relative term (e.g., despite the term “perceived”) as perceived intensity has a mathematical meaning. In particular, human eyes respond to light intensity logarithmically; hence, when optimizing the curves 302, 402 (and the like) for to maximize, such optimization is understood to occur in logarithmic space. Put another way, and again using the example of fifth order polynomials, nominal values for coefficients of a fifth order polynomial may be entered into modelling software (e.g., with certain constraints, such as a resulting curve, corresponding to the graph 302 may not bulge outward past a certain point, such as a width of the light emitting aperture 118, and the resulting curve starting from an edge of the aperture 112 and ending at an edge of the light emitting aperture 118, and the like), which also models resulting diffuse reflected brightness, for example in terms of luminance, and the like. The modeled diffuse reflected brightness may be determined on a logarithmic scale (e.g., a perceived brightness scale) and the coefficients of the fifth order polynomial may varied to maximize the logarithmic brightness (e.g., illuminance). By way of selecting the fifth order polynomial, and/or any other mathematically non-conical curved function (e.g., also excluding linear functions), the average perceived intensity of diffuse reflected light may be maximized relative to at least a conical surface.

Indeed, attention is next directed to FIG. 5 which depicts graphs 502, 504 respectively corresponding to illuminance along surfaces defined by the profile curves of the graphs 302, 402, with the “x” axis of the graphs 502, 504 provided in arbitrary units; for the graph 502, “0” point corresponds to an edge of the aperture 112, and the “100” point corresponds to an edge of the exit aperture 118; the “x” axis of the graph 504 begin and end at similar points.

Comparing maximize average perceived intensity determined from the curves 502, 504, the maximize average perceived intensity determined from the curve 502 (e.g., for the non-conical surface 120 defined by the graph 302) was determined to be on the order of about 10% higher than the maximize average perceived intensity determined from the graph 504 (e.g., for a conical surface defined by the graph 402). Such calculations also determined that variance of perceived intensities determined from the graph 502 was about. 31 (e.g., the variance determined as a sum of the squared delta between a sampled point and a mean of sampled points, where the sampled points are in the log space), whereas variance of perceived intensity determined from the graph 504 was about 0.85 e.g. Hence, it is further understood that the non-conical curved surface 120, between the light-emitting end 112 and the light-source end 118 may be alternatively optimized and/or selected to minimize variance of diffuse reflected light relative to at least a conical surface.

Furthermore, while herein intensity of diffuse reflected light was determined with respect to illuminance (e.g., as depicted in the graphs 502, 504), performing similar calculations with respect to luminance (e.g., optimizing the non-conical surface 120 to maximize average perceived intensity of diffuse light falling on the non-conical surface 120), as a similar result as optimizing to maximize average perceived intensity of diffuse reflected light. Indeed, optimizing to maximize average perceived intensity of diffuse reflected light from the non-conical surface 120 is understood to include optimizing to maximize average perceived intensity of diffuse light falling on the non-conical surface 120.

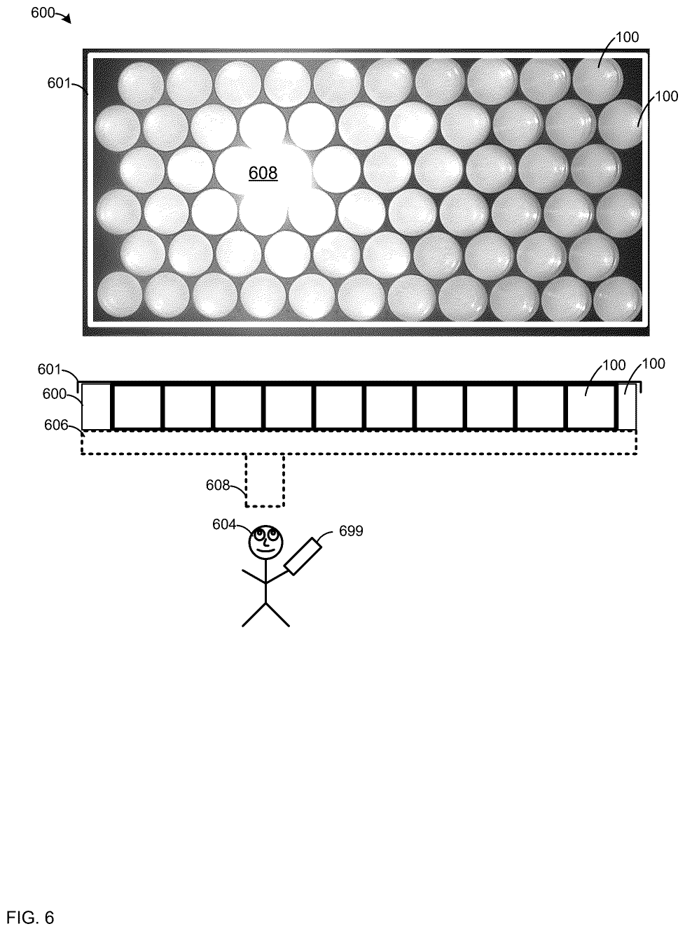

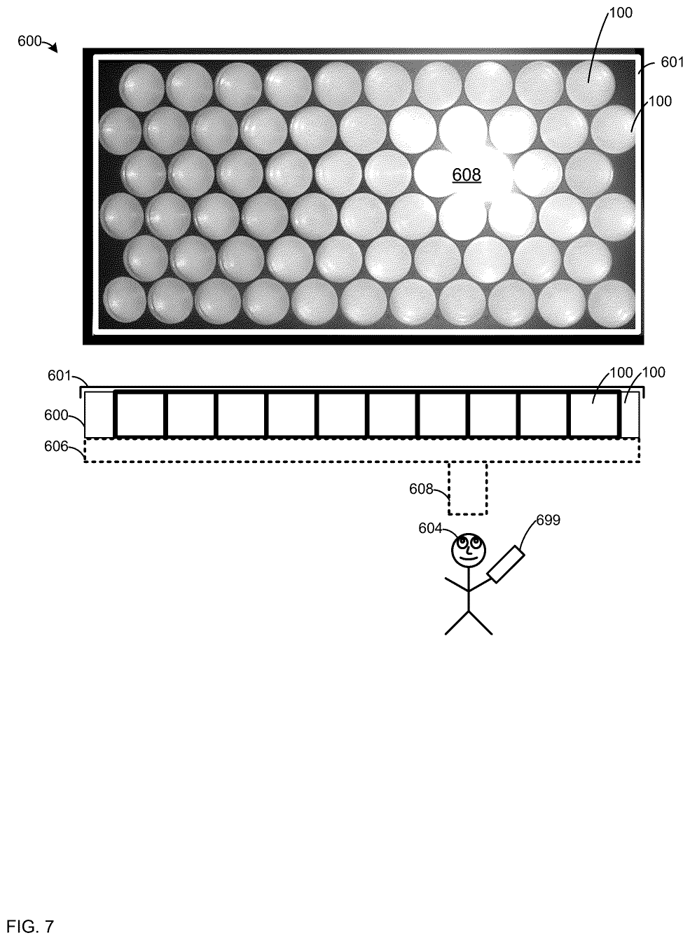

Attention is next directed to FIG. 6 and FIG. 7 which respectively depict an upward view of an example system 600 of the lamps 100 in a respective upper portion of FIG. 6 and FIG. 7, and, in a lower portion of FIG. 6 and FIG. 7, the system 600 is depicted schematically in a side view, as attached to a ceiling 602, with a viewer 604 at different positions relative to the system 600.

In FIG. 6 and FIG. 7, the system 600 comprises three rows of ten lamps 100 (e.g., with each circle in the system 600 in the upward view representing a respective lamp 100, and each rectangle in the side view representing a respective lamp 100), alternating with three rows of eleven lamps 100, for a total of sixty-three lamps, however only two lamps 100 are indicated for clarity. Furthermore, as depicted, the system 600 may comprise a frame (e.g., a troffer) and/or mounting plate 601 to which the lamps 100 may be attached. While the system 600 shows the lamps 100 tiled according to hexagonal packing in rows in a generally rectangular shape, the lamps 100 may be tiled in any suitable manner into any suitable shape.

As also seen in FIG. 6 and FIG. 7, the lamps 100 of the system 600 emit background scattered light 606 representing the sky, the background scattered light 606 being relatively uniform due to the non-conical curved surfaces 120 being optimized to maximize average perceived intensity of diffuse reflected light and the non-conical curved surfaces 120 comprising scattering surfaces. However, the viewer 604, looking up at the lamps 100 of the system 600 sees a brighter region 608 representing the sun, and the brighter region 608 follows the viewer 604, as the respective light sources 114 of the lamps 100 are located at a focal length and/or a focal point of the respective collimating lenses 116 of the lamps 100.

Hence, the viewer 604 experiences an illusion of the sun “following” the viewer 604, and/or remaining “stationary” and directly overhead of the viewer 604, in a background sky as the viewer 604 moves relative to the system 600. For example, in FIG. 6, the viewer 604 is towards a left side of the system 600, and sees the brighter region 608 formed by one or more of the lamps 100 directly overhead, and, in FIG. 7, the viewer 604 is towards a right side of the system 600, and sees the brighter region 608 formed by one or more of the lamps 100 directly overhead. The brighter region 608 is also indicated in FIG. 6 and FIG. 7 in the upward views of the system 600, which are now understood to be from a point of view of the viewer 604.

Put another way, the brighter region 608 seen by the viewer 604 is due the viewer 604 looking directly upwards into one or more collimating lenses 116 of the lamps 100 and as the viewer 604 moves, the point of view of the viewer 604 moves to different collimating lenses 116 of different lamps 100.

Furthermore, as will be presently described, the viewer 604 is holding a wireless remote control device 699 which may be used to control a brightness and/or color of the lamps 100 of the system 600. However, in other examples, the brightness and/or color of the lamps 100 of the system 600 may be controlled via a wired connection, for example to a switch and/or a dimmer switch, and the like, on a wall, and the like.

Some particular implementation details of the lamp 100 and the system 600 are next described, however such implementation details are understood to be examples only, and the lamp 100 and the system 600 may be implemented in any suitable manner where non-conical curved surfaces 120 are optimized to maximize average perceived intensity of diffuse reflected light

In particular, the collimating lens 116 may be a Fresnel lens or any suitable type of collimating lens.

Furthermore, while as depicted herein the collimating lens 116 may be circular, the collimating lens 116 may be of any suitable shape. For example, the collimating lens 116 may be hexagonal (e.g., the exit aperture 118 may be hexagonal), or any other suitable shape. In examples where the collimating lens 116 is hexagonal and/or non-circular, the non-conical curved surface 120 may be rotationally symmetrical about the longitudinal axis 101 at the light-source end 108, but transition to hexagonal and/or non-circular symmetry about the longitudinal axis 101 towards the light-emitting end 110 (e.g., to account for a hexagonal and/or non-circular exit aperture 118).

Alternatively, in examples where the collimating lens 116 may be hexagonal and/or non-circular, but the exit aperture 118 is circular, the non-conical curved surface 120 may maintain rotational symmetry about the longitudinal axis 101, and the lamp 100 may further comprise a round shaped lens holding portion comprising a hexagonal and/or non-circular aperture for holding the collimating lens 116, that inserts into the exit aperture 118 (e.g., for up to 10% to 20% of the focal length of the collimating lens 116, amongst other possibilities). Such a lens holding portion may be colored white, or be the same color as the non-conical curved surface 120.

In some specific examples, the collimating lens 116 may be about 100 mm in diameter, with a focal length of about 100 mm, with the housing 102 adapted accordingly, which results the lamp 100 being of a size and shape that is easily handleable by human, and which is small enough to provide a thickness (depth) which is not overly cumbersome for installations of the lamps 100 into artificial skylights on ceilings (e.g., such as the system 600), and the like.

Furthermore, when the collimating lens 116 has a diameter much larger than 100 mm and focal length much larger than 100 mm, the lamp 100 may become harder to manufacture (e.g., using injection molding techniques) and furthermore, as light output of the lamp 100 is generally proportional to a surface area of the exit aperture 118, as the diameter and focal length of the collimating lens 116 increases, a power usage and brightness of the light source 114 may increase to achieve similar power usage and brightness of a smaller lamp 100. For example, with the collimating lens 116 having a diameter and focal length, each off about 100 mm, the light source 114 may be about 1000 lumens, and LEDs of this brightness are both easy to source and cool.

It is furthermore understood that, regardless of the diameter of the collimating lens 116, in some examples, the focal length may be about the same as the diameter (e.g., both may be about 100 mm). In particular, focal lengths of collimating lenses that are much shorter than diameters of the collimating lenses tend to have progressively more optical distortion. In some examples, a minimum relative focal length of the collimating lens 116 may be up to about half the diameter of the collimating lens 116, however. Furthermore, focal lengths of collimating lenses that are much longer than diameters of the collimating lenses are progressively less efficient in light output, as much of the light is absorbed by the (e.g., blue diffuse/scattering interior). In some examples, a focal length of the collimating lens 116 may have a maximum ratio of about 1.5

Regardless, the focal length of the collimating lens 116 is generally selected to be within the interior of the housing 102.

The light source 114 may comprise an LED, or an array of LEDs, and the like. A brightness of a single LED, or the array of LEDS may be about 1,000 lumens, however the brightness of the single LED, or the array of LEDS may be in a range of about 500 lumens to about 3,000 lumens. In another example, the brightness of the single LED, or the array of LEDS may be in a range of about 200 lumens to about 2,000 lumens. However, it is understood that higher brightnesses may lead to more heat, and hence larger heat sinks, and the like.

Furthermore, the CCT of the light source 114 may be a single CCT which approximates a color of the sun, for example in a range about 2700K to about 6500K, or a CCT of the light source 114 may be tunable between about 2700K and about 6500K, or any other suitable range. In a particular example, the CCT of the light source 114 may be in a range of about 3000K to about 5000K.

The light source 114 may be circular, and/or any other suitable shape, and of a size and shape that enables the light source 114 to be positioned at, or behind, the aperture 112.

In a particular examples, the light source 114 may comprise an about 10 mm diameter LED array, with the aperture sized accordingly. However, the light source 114 may be of any suitable size and shape, such as a rectangular 2 mm LED array that fits inside, or behind the aperture 112.

Indeed, a successful prototype included a circular light source 114 of about 10 mm diameter in diameter, comprising a 1000 lumen LED having a luminance of about 1M cd/m². However when smaller LEDs are used for the light source 114 (e.g., 1-2 mm) more flexibility in a shape and/or brightness thereof. For example, LEDs on an order of about 1 to 2 mm may be almost any shape, but larger LEDs, for example, greater than 5 mm in diameter may be circular to better approximate a shape of the sun. Furthermore, LEDs on an order of about 1 to 2 mm may have lower over brightness, in lumens, to achieve a same and/or similar luminance as the aforementioned 10 mm diameter LED. Hence, there may be advantages to using smaller LEDs.

The light source 114 is further understood to be located along the longitudinal axis 101 (e.g., of the collimating lens 116), and located at or about the focal point of the collimating lens 116. In particular, the light source 114 may be located within a distance from the focal point that is in a range of about 1% to about 5% of the focal length.

In some examples, the exterior 104 of the housing 102 may be provided with a matte surface finish, and the exterior 104 may be colored black (or any other suitable color).

As has been previously described, the non-conical curved surface 120 may be colored blue and/or sky blue and/or may be in any suitable CIELAB color range.

The housing 102 may comprise any suitable material, including, but not limited to, High-Density Polyethylene (HDPE), polycarbonate, polyamide (e.g., nylon), and the like, and may be manufactured in any suitable manner, such as injection molding, three dimensional printing, and the like.

Furthermore, the exterior 104 of the housing 102 may be constrained to be within or about the same as, an exterior edge of the collimating lens 116 and/or a hexagonal (and/or tileable) portion of the housing 102. In particular, the exterior 104 of the housing 102 may generally be hexagonal, at least around the collimating lens 116, and a surface of the exterior 104 may not bulge outward beyond the hexagonal part of the exterior 104 so not to impede tiling of the lamp 100 with other, similar, lamps 100 (e.g., as in the system 600).

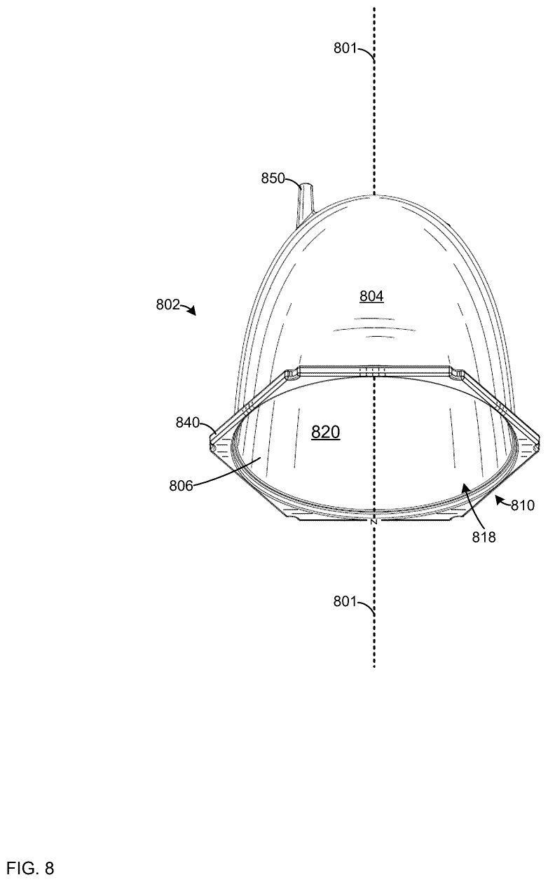

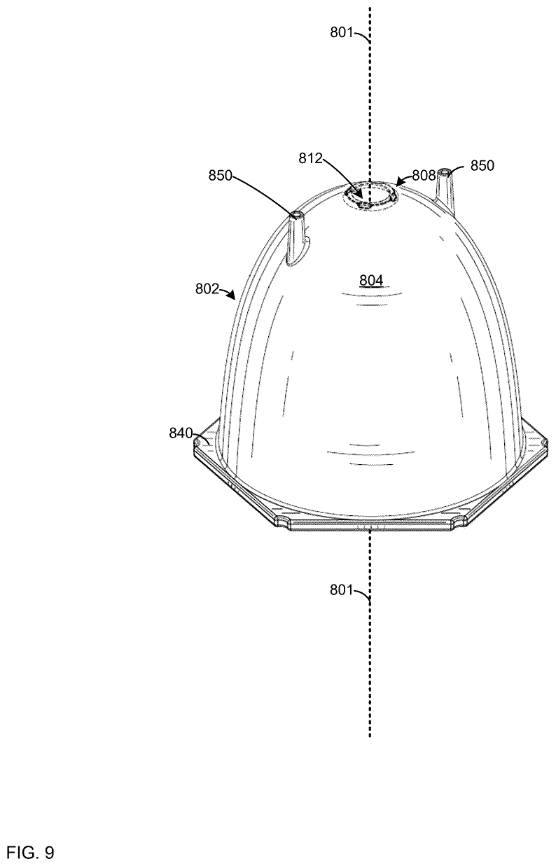

Attention is next directed to FIG. 8 and FIG. 9 which respectively depicts a bottom perspective view and a top perspective view of an alternative housing 802 for the lamp 100. In particular, similar components of the housing 802 are understood to be similar to the components of the housing 102, with similar components having similar numbers but in an “800” series rather than a “100” series. Hence, the housing 802 is arranged around a longitudinal axis 801, and comprises an exterior 804 and interior 806, a light-source end 808 and light-emitting end 810 opposite the light-source end 808, an aperture 112 through the light-source end 808, a respective exit aperture 818 through the light-emitting end 810, and a non-conical curved surface 820 of the interior 806. At least the longitudinal axis 801, the interior 806, the light-source end 808, the light-emitting end 810, the exit aperture 818 and the non-conical curved surface 820 are understood to be respectively similar to the longitudinal axis 101, the interior 106, the light-source end 108, the light-emitting end 110, the exit aperture 118 and the non-conical curved surface 120

However, in contrast to the exterior 104, the exterior 804 generally follows the non-conical curved surface 120, for ease of manufacture, other than a lip 840 around the exit aperture 118, which as depicted, is of a hexagonal shape and may be used to tile a lamp 100 incorporating the housing 802 with other similar lamps 100. The lip 840 is understood to be the widest part of the exterior 804 around the longitudinal axis 801, with the remainder of the exterior 804 being less than a width of the lip 840. The lip 840, however, may be of any suitable tileable shape.

However, similar to the housing 102 of FIG. 1, the lamp 100 may have a hexagonal outer profile, that, when assembled (e.g., into the system 600) forms a honeycomb structure, which may serve as structural support for an array of lamps 100.

However both structures of the housings 102, 802 may be used to form lamps 100 into an array and/or honeycomb structure, for example by locating holes, and the like, at housings 102, 802 that align when lamps 100 are adjacent, and through which fasteners may be positioned to fasten the lamps 100 together.

Alternatively, or in addition, and again with reference to FIG. 8 and FIG. 9, the housing 802 (and/or the housing 102), may comprise (e.g., one or more) structures 850 for mounting a heatsink to the housing 802 (e.g., as depicted two structures 850 arranged about symmetrically on either side of the aperture 808. The structures 850 may comprise prongs, and the like, that extend from the exterior 804 about parallel to the longitudinal axis 802, to about a same height as a location of the aperture 808, the prongs including fastener receiving apertures, and the like at their respective end, so that a heatsink (not depicted) may be attached to the housing 802 (e.g., using any suitable fasteners such as screws or bolts) and extend across the aperture 808 to make thermal contact with a light source, and to draw heat away from the light source.

However, any suitable tileable shape for a housing 102, 802 is within the scope of the present specification.

Furthermore, any suitable mounting structures are within the scope of the present specification.

Turning now to an example system of the lamps 100, such as the system 600, controllers 130 of lamps 100 of such a system 600 may be used to control the lamps 100 to a uniform brightness (to within 2%, 5%, 10%, amongst other possibilities) and/or light sources 114 of such lamps 100 may be selected to be within a 2%, 5%, 10% of each other, amongst other possibilities, to provide such a uniform brightness. Example systems of the lamps 100 will now be described with reference to the system 600, however features described with respect to the system 600 may be applied to any suitable system of the lamps 100.

In some examples, the system 600 may comprise a frame and/or a mounting plate, such as the frame and/or a mounting plate 601, to which a plurality of the lamps 100 may be attached (e.g., via any suitable mounting structures and/or schemes, and the like). Furthermore, such a frame and/or mounting plate 601 may include a central power supply and/or power supply connector to which the controllers 130 of the lamps 100 may be connected to power the lamps 100. Alternatively, or in addition, the controllers 130 of the lamps 100 may be in communication and/or interconnected (e.g., via connections between the controller 130 and/or via connections at the frame and/or mounting plate 601, and the like), for example to provide control of the light sources 114 of the lamps 100 in a coordinated manner. Alternatively, or in addition, the frame and/or mounting plate 601 may comprise a central controller to which the light sources 114 of the lamps 100 may be connected for central control of the light sources 114. Alternatively, or in addition, one controller 130 of the controllers 130 of the lamps 100 may be designated as a primary controller 130 and the remainder of the controllers 130 of the lamps 100 may be designated as secondary controllers 130 controlled by the primary controller 130, and the primary controller 130 may provide central control of the light sources 114; such designations may be assigned to the controllers 130 via software switches at the controllers 130, and the like.

In some examples, a brightness and/or color of the lamps 100 may be adjustable, for example over time. In particular, a lamp 100 and/or the system 600 (and/or the frame and/or mounting plate 601) may be provided with one or more brightness detectors and/or color detectors for detecting changes in brightness and/or color of individual lights sources 114 of the lamps 100 over time (e.g., one brightness detector and/or color detector per lamp 100), and a controller 130 and/or controllers 130 may be in communication with such detectors, in a feedback loop, to control the light sources 114 to a given brightness and/or a given color, and/or to maintain a given brightness and/or a given color over time. Setting of the given brightness and/or a given color may be predetermined and programmed into the controller 130 and/or controllers 130, and/or selection of the given brightness and/or given color may occur via the wireless remote control device 699 (e.g., operated by the viewer 604) in communication with one or more controllers 130 of the system 600, and/or a wired control device (e.g., a wall switch and/or dimmer, and the like).

In some examples (which may be combined, or not, with the aforementioned brightness and/or color control over time), the lamps 100 of the system 600 (or an individual lamp 100) may dimmed using a manual switch and/or dimmer, and/or the lamps 100 of the system 600 (or an individual lamp 100) may be color controlled using a manual switch, and the like. Such dimming and/or color control may occur via one or more controllers 130 of the system 600, and such dimming and/or color control may occur via a manual switch and/or dimmer at the system 600 and/or via the wireless remote control device 699 device in communication with one or more controllers 130 of the system 600.

In some examples, the lamps 100 of the system 600 may be controlled via one or more controllers 130 according to time, for example to brighten (and/or turn on) and dim (and/or turn off) the light sources 114 according to a schedule which may match sunrise and sunset in a region where the system 600 is located. Such a schedule may alternatively control colors of the light sources 114. For example, such a schedule may control the light sources 114 to mimic brightness and/or color of the sun over a 24 hour period and/or a day. Such a schedule may be implemented programmatically (e.g., via one or more of the controllers 130) via a clock (e.g., of one or more of the controllers 130, or another clock with which the one or more controllers 130 are in communication). Such a schedule may alternatively be controlled via the wireless remote control device 699.

Alternatively, and/or in addition, such a schedule may be implemented by matching light (e.g., brightness and/or color) of the sun sensed by a light sensor (e.g., a camera, a photocell, a solar cell, amongst other possibilities) which may be mounted outdoors and/or next at a window, and which may be in communication with one or more of the controllers 130, which may control brightness and/or color of the light sources 114 accordingly (e.g., according to senses brightness and/or color, which may also be affected by clouds, or lack thereof, in a sky). In some examples, such a light sensor may be incorporated into one or more of the controllers 130 and/or the wireless remote control device 699.

In some examples, a brightness and/or color of the light sources 114 may be controlled to mimic the sun at noon, and/or a brightness and/or color of the light sources 114 may be controlled to mimic the sun at sunrise or sunset, and/or such control may according to a schedule, for example to mimic a brightness and/or color of the sun from sunrise to noon to sunset, and the like. Such control of brightness and/or color of the light sources 114 to mimic the sun at noon and/or the sun at sunrise or sunset, may alternatively be controlled via the wireless remote control device 699.

The frame and/or mounting plate 601 may comprise a flat plate to which the lamps 100 may be mounted (e.g., using any suitable fasteners, and the like). Such a flat plate may include sides, and the like, around the lamps 100.

The frame and/or mounting plate 601 may comprise a flat plate having cutouts therethrough (e.g., which may be circular and/or hexagonal, and/or which may be matched to a tileable shape of the lamps 100), through which the lamps 100 may be inserted to assist at supporting the lamps 100, and such cutouts may include respective holding mechanisms to hold lamps 100 therein (e.g., such as clips, and/or any other suitable frictional holding mechanisms). Such a frame and/or mounting plate 601 may optionally include a second flat plate behind the cutouts to which the lamps 100 may be mounted and/or electrically interconnected.

For example, the frame and/or mounting plate 601 may include any suitable electrical connectors and/or controllers to electrically connect the lamps 100 mounted thereto.

The frame and/or mounting plate 601 may be made of any suitable rigid material and/or materials including, but not limited to, any suitable combination of metal and/or plastic.

However, as the lamps 100 may be light (i.e. not heavy), one or more lamps 100 may be mounted to any suitable surface (e.g., such as a ceiling, or in some examples, a wall) directly, and/or without a frame and/or mounting plate. In these examples, a housing 102, 802 of the lamps 100 may be adapted for such direct mounting, for example to include apertures that accommodate fasteners, such a screw and/or bolts, for attachment of the lamps 100 to a surface.

In some examples, a scattering of light from the system 600, may be controlled via a unit placed between the lamps 100 of the system 600 and the viewer 604, such as a liquid crystal cell, a Polymer Dispersed Liquid Crystal (PDLC) cell, a Suspended Particle Device (SPD) cell, “Smart Glass™”, and the like, for example to mimic a cloudy day, and/or clouds moving in front of the sun (e.g., over time), for example using a controller 130 and/or another controller.

For example, attention is next directed to FIG. 10, which is similar to a lower portion of FIG. 7, and which shows the viewer 604 looking up at the system 600. However, in this example, the system 600 includes a unit 1002 (e.g., which may comprise a liquid crystal cell, a PDLC cell, an SPD (Suspended Particle Device, cell, “Smart Glass™”, and the like) positioned between the lamps 100 and the viewer 604, and through which the scattered light 606 and light of the brighter region 608 is filtered. A scattering parameters of the unit 1002 may be controlled via any suitable controller (e.g., one or more of the controllers 130 and/or the wireless remote control device 699) to control scattering of the scattered light 606 and light of the brighter region 608. In such examples, scattering of the lamps 100 may be fixed and scattering of the scattered light 606 and light of the brighter region 608 may be controlled via the unit 1002. For example, the unit 1002 may be controlled between a generally transparent state, at least one partially opaque (e.g., cloudy) state, and an opaque state. In at least one partially opaque (e.g., cloudy) state and the opaque state, scattering of light from the lamps 1002 may increase relative to the transparent state.

While the unit 1002 is depicted as extending over an entire surface of all the lamps 100, in other examples, an individual lamp 1000 may be provided with a respective unit similar to the unit 1002.

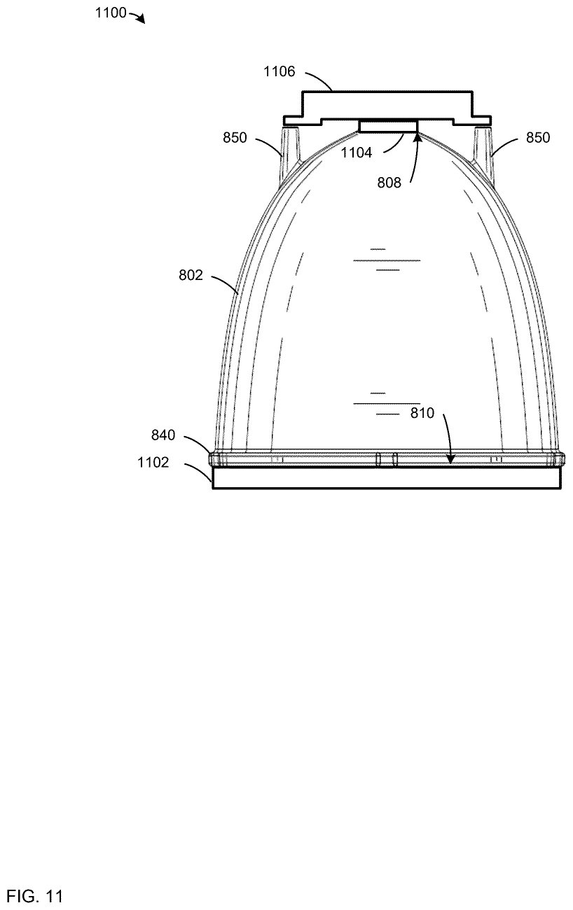

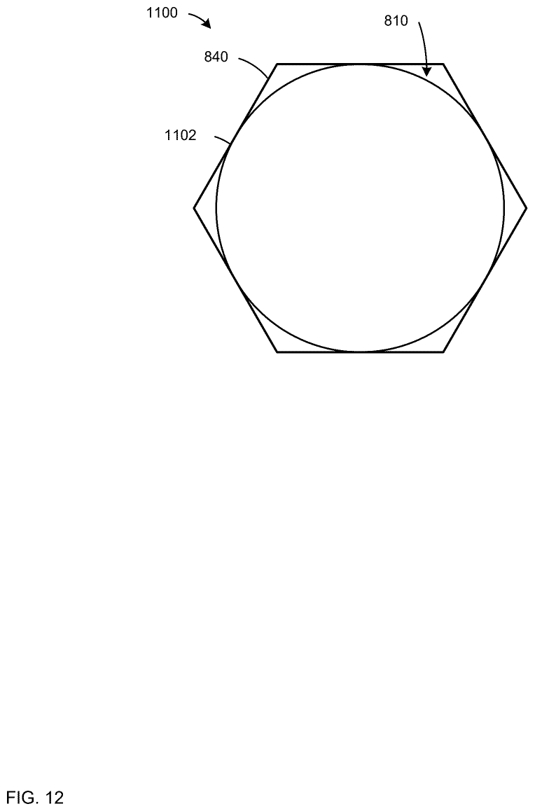

For example, attention is directed to FIG. 11 and FIG. 12, which respectively schematically depict a side view and an light emitting end view of a lamp 1100, similar to any of the lamps 100 described herein, but adapted to include the housing 802, a unit 1102 at the light emitting end 810 of the housing 802, a light source 1104 (e.g., similar to the light source 114) at the light-source end 808, and a heatsink 1106 attached to the housing via the structures 850 (e.g., and respective fasteners, not depicted).

The unit 1102 may be adjacent and/or attached to the lip 840, and may have the same or similar functionality as the unit 1002. However, the unit 1102 has dimensions adapted for the lamp 1100, rather than a plurality of lamps 100, 1100. The unit 1102 may be a same shape (e.g., hexagonal) as the lip 840 such that the unit 1102 is tileable with other units 1102 of adjacent tiled lamps 1100, or the unit 1102 may have a shape and/or suitable dimensions that do enables the unit 1102 to filter and/or scatter light emitted from the light emitting end 810 of the housing 802 as described with respect to the unit 1002, and which does not interfere with the lamps 1100 being tiled. For example, as a hexagonal unit 1102 may be challenging to manufacture, as depicted in FIG. 12, the unit 1102 may be circular, have dimensions that enable the unit 1102 to be attached to the lip 840, and remain within the hexagonal shape of the lip 840.

FIG. 11 further depicts the heatsink 1106 being across a rear of the light source 1104 to remove heat from the light source 1104.

It is further understood that instance of the term “configured to”, such as “a computing device configured to . . . ”, “a processor configured to . . . ”, “a controller configured to . . . ”, and the like, may be understood to include a feature of a computer-readable storage medium having stored thereon program instructions that, when executed by a computing device and/or a processor and/or a controller, and the like, may cause the computing device and/or the processor and/or the controller to perform a set of operations which may comprise the features that the computing device and/or the processor and/or the controller, and the like, are configured to implement. Hence, the term “configured to” is understood not to be unduly limiting to means plus function interpretations, and the like.

Furthermore, descriptions of one processor and/or controller and/or device and/or engine, and the like, configured to perform certain functionality is understood to include, but is not limited to, more than one processor and/or more than one controller and/or more than one device and/or more than one engine, and the like performing such functionality.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that in some examples, the functionality of devices and/or methods and/or processes described herein may be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein may be achieved using a computing apparatus that has access to a code memory (not shown), which stores computer-readable program code for operation of the computing apparatus. The computer-readable program code could be stored on a computer readable storage medium, which is fixed, tangible and readable directly by these components, (e.g., removable diskette, CD-ROM, ROM, fixed disk, USB drive). Furthermore, it is appreciated that the computer-readable program may be stored as a computer program product comprising a computer usable medium. Further, a persistent storage device may comprise the computer readable program code. It is yet further appreciated that the computer-readable program code and/or computer usable medium may comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium may be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative examples and modifications possible, and that the above examples are only illustrations of one or more examples. The scope, therefore, is only to be limited by the claims appended hereto.

1. A lamp comprising:
a housing having an interior and an exterior, the interior having a light-source end and light-emitting end opposite the light-source end;
an aperture through the light-source end of the interior;
a light source located at or behind the aperture, the light source arranged to emit light through the aperture towards the light-emitting end; and
a collimating lens located at the light-emitting end,
the interior comprising a non-linear, non-conical curved surface, between the light-emitting end and the light-source end optimized to maximize average perceived intensity of diffuse light falling on the non-linear, non-conical surface-,
wherein optimizing to maximize the average perceived intensity occurs in logarithmic space,
wherein the non-linear, non-conical curved surface follows at least a third order polynomial, and
wherein the non-linear, non-conical curved surface comprises a scattering surface.

2. The lamp of claim 1, wherein a cross-section through a longitudinal axis of the non-linear, non-conical curved surface follows a fifth order polynomial with an origin of the fifth order polynomial beginning at an edge of the aperture.

3. The lamp of claim 1, wherein the non-linear, non-conical curved surface is colored in a range of 1931 CIE (Commission Internationale de l'éclairage) corresponding to one or more of blue and a color of the sky.

4. The lamp of claim 1, wherein the non-linear, non-conical curved surface has a color in a 1931 CIE range of one of [(X:0.200 Y:0.100) to (X:0.150 Y:0.200) to (X:0.300 Y:0.340)] or [(X:0.200 Y:0.100) to (X:0.150 Y:0.200) to (X:0.380 Y:0.377)].

5. The lamp of claim 1, wherein the non-linear, non-conical curved surface widens from the light-source end to the light-emitting end.

6. The lamp of claim 1, wherein the exterior of the housing is a tileable shape in a cross-section through a plane to which a longitudinal axis of the non-linear, non-conical curved surface is normal, at least at the light-emitting end.

7. The lamp of claim 1, wherein the exterior of the housing is hexagonal in cross-section, at least at the light-emitting end.

8. The lamp of claim 1, wherein the collimating lens comprises a Fresnel lens.

9. The lamp of claim 1, wherein a diameter of the collimating lens is in a range of about 80 mm to about 120 mm.

10. The lamp of claim 9, wherein a focal length of the collimating lens is in a range of about 80 mm to about 120 mm, and the light source is located at a focal point of the collimating lens.

11. The lamp of claim 1, further comprising a unit at the light emitting end configured to control scattering of the light from the light source.

12. A system comprising:
a plurality of lamps arranged in an array, each of the plurality of lamps comprising:
a housing having an interior and an exterior, the interior having a light-source end and light-emitting end opposite the light-source end;
an aperture through the light-source end of the interior;
a light source located at or behind the aperture, the light source arranged to emit light through the aperture towards the light-emitting end; and
a collimating lens located at the light-emitting end,
the interior comprising a non-linear, non-conical curved surface, between the light-emitting end and the light-source end optimized to maximize average perceived intensity of diffuse light falling on the non-linear, non-conical surface,
wherein optimizing to maximize the average perceived intensity occurs in logarithmic space,
wherein the non-linear, non-conical curved surface follows at least a third order polynomial,
and
wherein the interior comprises a scattering surface.

13. The system of claim 11, wherein a cross-section through a longitudinal axis of the non-linear, non-conical curved surface follows a fifth order polynomial with an origin of the fifth order polynomial beginning at an edge of the aperture.

14. The system of claim 11, wherein the non-linear, non-conical curved surface is colored in a range of 1931 CIE (Commission Internationale de l'éclairage) or CIELAB coordinates corresponding to one or more of blue and a color of the sky.

15. The system of claim 11, wherein the non-linear, non-conical curved surface has a color in a 1931 CIE range of one of [(X:0.200 Y:0.100) to (X:0.150 Y:0.200) to (X:0.300 Y:0.340)] or [(X:0.200 Y:0.100) to (X:0.150 Y:0.200) to (X:0.380 Y:0.377)].

16. The system of claim 11, wherein the non-linear, non-conical curved surface widens from the light-source end to the light-emitting end.

17. The system of claim 11, wherein the exterior of the housing is a tileable shape in cross-section, at least at the light-emitting end.

18. The system of claim 11, wherein the exterior of the housing is hexagonal in cross-section, at least at the light-emitting end.

19. The system of claim 11, wherein the collimating lens comprises a Fresnel lens.

20. The system of claim 11, wherein a diameter of the collimating lens is in a range of about 80 mm to about 120 mm and a focal length of the collimating lens is in a range of about 80 mm to about 120 mm, and the light source is located at a focal point of the collimating lens.
